(19) United States
(12) Patent Application Publication
(10) Pub. No.: US 2011/0051943 A1
(43) Pub. Date: Mar. 3, 2011

(54) METHOD FOR ADJUSTING A HEARING AID AND HEARING AID ADJUSTMENT INSTRUMENT

(75) Inventors: ULRICH GIESE, Fuerth (DE); HEIKE HEUERMANN, Hamburg (DE); MATTHIAS LATZEL, Eggolsheim (DE)

(73) Assignee: SIEMENS MEDICAL INSTRUMENTS PTE. LTD., Singapore (SG)

(21) Appl. No.: 12/870,962

(22) Filed: Aug. 30, 2010

(30) Foreign Application Priority Data
Aug. 28, 2009 (EP) 09168936
Mar. 29, 2010 (EP) 10158156

(51) Int. Cl. H04R 29/00

(52) U.S. Cl. 381/60

(57) ABSTRACT

Optimized hearing aid parameter settings are automatically determined from a multiplicity of data obtained by applying different test methods for testing the auditory perception of a person. Data pertaining to the auditory perception (audiological data) of the user are first obtained by different test methods. The data from the individual tests can be incomplete, inconsistent or untypical, or even erroneous. However, the subsequent combination of where possible all available data in a computational unit affords the possibility of automatically obtaining hearing aid parameter settings by way of which a hearing aid operated thereby compensates the present loss of hearing of the relevant user in an optimized fashion.

### CROSS-REFERENCE TO RELATED APPLICATION

This application claims the priority, under 35 U.S.C. §119, of European patent applications Nos. EP 09168936, filed Aug. 28, 2009, and EP 10158156, filed Mar. 29, 2010, the prior applications are herewith incorporated by reference in their entirety.

### BACKGROUND OF THE INVENTION

### Field of the Invention

The invention relates to a method for automatically adjusting a transmission function of a hearing aid to the individual loss of hearing of a user for a particular frequency range. The invention furthermore relates to a hearing aid adjustment instrument that is suitable for carrying out the method.

A transmission function of the hearing aid is more particularly understood to be the frequency response of the hearing aid, that is to say the amplification of an input signal as a function of the frequency of the input signal. In addition to the frequency of the input signal, the transmission function can also depend on further signal properties, e.g. the signal level. Thus the transmission function also determines the signal-level dependent amplification (compression). Moreover, the transmission function also depends on whether certain signal-processing algorithms, e.g. for the noise removal, are switched on or off or whether a directional effect is set in the microphone system of a relevant hearing aid. In general, the transmission function is determined to a significant extent by the signal-processing algorithm or signal-processing algorithms running in the signal-processing unit of the hearing aid, wherein influence can be exerted thereon by adjusting parameters. Such parameter settings can be used to adjust the transmission function with respect to the individual loss of hearing of a user.

The transmission function of a hearing aid is generally adjusted to the individual loss of hearing of the user as a result of the dialog between a hearing aid wearer and an audiologist. In the process, the hearing aid wearer is presented with different test signals, which are perceived subjectively by the wearer and the latter informs the audiologist about their impressions. Said audiologist compares the perception of the hearing aid wearer in respect of the respective test signal to the perception of people with normal hearing. The audiologist derives hearing aid parameter settings from the different perceptions, which settings generally lead to an improved setting of the hearing aid to the hearing aid wearer, more particularly these lead to individually optimized signal processing. This procedure is repeated until the person who is hard of hearing subjectively perceives a number of test signals like a person who has normal hearing.

There are situations that do not allow recording a standard audiogram on the basis of which the adjustment could be performed. Developing countries, in which the required audiometric equipment is lacking, are an example of this. Uncooperative patients, such as small children or some people with multiple disabilities, are a further example. Sufficiently quiet surroundings required for carrying out pure tone audiometry are also often lacking. Thus, it is often necessary to fall back onto other test methods for obtaining data in respect of the auditory perception of a person.

In addition to the pure tone audiometry, a multiplicity of further instruments and test methods are known by means of which an impression can be gathered of the capabilities of a person in respect of the auditory perception. These include simple hearing test equipment, programs for online audiometry over the Internet, clinical supra-threshold tests or speech intelligibility tests in quiet and in noise. Questionnaires in respect of typical symptoms of the respective loss of hearing can also be used.

U.S. Pat. No. 4,471,171 and its counterpart German published patent application DE 32 05 685 A1 describe a hearing aid with a test tone generator, by means of which audiological data from a user can be obtained in a simple fashion. The hearing aid independently converts the audiological data into hearing aid parameter settings, by means of which the hearing aid carries out a transmission function for compensating the measured loss of hearing.

Commonly assigned European published patent application EP 1 073 314 A1 describes a method for adjusting the signal-processing unit of a hearing aid individually to a user, in which a measuring arrangement registers different auditory, involuntary body signals of the user and evaluates these for automatically generating hearing-aid specific adjustment parameter settings. The involuntary body signals include for example otoacoustic emissions (OAE) and acoustic evoked potentials (AEP).

It is a disadvantage of the prior art methods for adjusting a hearing aid to the individual loss of hearing of a user that these often supply incomplete, inconsistent or erroneous adjustment parameter settings.

### SUMMARY OF THE INVENTION

It is accordingly an object of the invention to provide a device and a method for adapting a hearing aid which overcome the above-mentioned disadvantages of the heretofore-known devices and methods of this general type and which provides for optimized hearing aid parameter settings from a multiplicity of data obtained by applying different test methods for testing the auditory perception of a person.

With the foregoing and other objects in view there is provided, in accordance with the invention, a method for automatically adapting a transmission function of a hearing aid to an individual loss of hearing of a user, the method which comprises:

performing different tests and applying different test methods for obtaining data relating to an auditory perception of the user; and

determining the transmission function in dependence on the data obtained in the different tests, and thereby differently weighting the data obtained in the different tests when determining the transmission function.

In a preferred embodiment, the data obtained in the different tests are weighted with frequency-dependent weighting for determining the transmission function.

In other words, the basic concept of the invention consists of obtaining data in respect of the auditory perception (audiological data) of the user from different tests by applying different test methods. Depending on the respective test method and also on the progress of individual tests, the obtained data is more or less suitable for automatically determining individual portions of the transmission function. Thus, the obtained data is weighted to that effect that it—depending on the underlying test method—has more or less influence on determining a certain portion of the transmission function. In the extreme case, the weighting can go that far that the data obtained from a certain test method exerts no influence on a certain portion of the transmission function (its “weighting” is “zero” in respect thereof) or that a certain portion of the transmission function is determined exclusively by the data emerging from applying a certain test method (the “weighting” of which therefore equals “one”). However, in general the data emerging from a plurality of tests will have a greater or lesser influence on determining a certain portion of the transfer function.

The basic concept of the invention more particularly consists of obtaining, in each case for a portion of the frequency range (part-frequency range) transmissible by the hearing aid, particularly meaningful data in respect of the auditory perception (audiological data) of the user in said part-frequency range from different tests by applying different test methods. By combining the data obtained for the individual frequency ranges, an optimized transmission function of the hearing aid can then be determined for compensating an individual loss of hearing for the entire transmittable frequency range. The data emerging from the different tests are thereby weighted differently when determining the transmission function as a function of the frequency. In the extreme case, this can even lead to each test determining the transmission function exclusively for a certain part-frequency range.

Here, a test within the scope of the invention should be understood as meaning the application of a certain test method, wherein a test can also comprise a multiplicity of individual tests, for example the requirements of different frequencies and signal levels in pure tone audiometry. More particularly, within the scope of the invention, a test can also be an iterative process.

More particularly, the following methods are mentioned as examples of test methods for obtaining audiological data, which methods allow different assessments of the hearing:

Tone audiometry for air conduction (by means of headphones or speakers) or bone conduction (by means of bone conduction receivers):
Tone audiometry is used in particular for determining the function of the inner ear and middle ear, for determining the hearing threshold and the discomfort threshold, and the sound conduction proportions of the loss of hearing.

Loudness scaling (by means of headphones or speakers):
Loudness scaling is used to determine the function of the inner ear, more particularly to determine the loudness function between hearing threshold and discomfort threshold.

Methods for determining the level, frequency and time resolution capability: These are used for determining the function of the inner ear.

Methods for localization: These are used for determining the binaural balance, more particularly of the audiological function of the brainstem.

Methods for determining the speech intelligibility in general (in quiet and in noise): These are used for determining cortical processing and attentiveness.

Specific test methods for registering speech intelligibility: These additionally allow an estimation of quiet hearing thresholds without tone audiometry being present. By way of example, this allows conclusions to be drawn about the quiet hearing threshold in the deep-tone range from the understanding of counting words.

A prerequisite for using the aforementioned methods is the active cooperation of the test persons, which sometimes may only be limited, e.g. in small children, in multiply-handicapped, unconscious or uncooperative test persons. In this case, a host of physiological test methods have already been developed, which, like the behavioral-based methods, test different regions of the hearing. More particularly, the following are mentioned here:

Middle ear impedance measurement (tympanometry and stapedius reflex):
This test method is used for determining the function of the middle ear, estimating the discomfort threshold and the loudness balancing and the sound conduction proportions of the loss of hearing.

Measurement of otoacoustic emissions:
This test method is used for determining the function of the inner ear and the frequency-specific function of the outer hair cells.

Measurement of brainstem potentials/brainstem evoked response audiometry (BERA):
This test method is used for (frequency-specific) checking of the auditory pathway, estimating the hearing threshold, the sound conduction loss of hearing and inner ear loss of hearing.

Measurement of the cortical potentials/cortical evoked response audiometry (CERA):
This test method is used for determining the frequency-specific processing in the cortex and attentiveness effects.

Measurement of event correlated potentials (ERP):
This test method is used for determining the central perception processing, more particularly the speech intelligibility.

Depending on the respectively diagnosed functional disorder of the auditory system, different hearing aid settings are required for optimizing certain portions of the transmission function of the hearing aid and thereby obtaining an optimized compensation for the loss of hearing. Thus, the components of middle ear damage and inner ear damage on the overall loss of hearing have a direct influence on the frequency-specific amplification curve, while the loudness function or the function of the outer hair cells determine the dynamic compression of the hearing aid. The resolving capability in the inner ear and the functions of the central hearing (localization, speech intelligibility, and CERA and ERP) in turn can be improved by specific additional algorithms in the hearing aid such as noise suppression or speech-sensitive processing. An examination that is a precise as possible of these various stages of auditory processing is therefore clearly advantageous.

According to the invention, the influence that the data obtained by means of a certain test method, that is to say the data emerging from a certain test, should have on determining a certain portion of the transmission function is fixed. Accordingly, the “weighting” of the data entered into calculating the transmission function and, more particularly, a certain portion of the transmission function is fixed. Thus, by way of example, “weightings” are fixed in the individual test methods for various signal frequencies in order to determine the portion of the transmission function that fixes the amplification of an input signal entering the hearing aid as a function of the signal frequency. By way of example, a speech intelligibility test obtains a particularly high weighting in the frequency range between 500 Hz and 3 kHz that is particularly relevant for speech and a low weighting in the other frequency ranges, which weighting can also equal “zero”.

The weighting of the test methods in respect of their influence when determining the transmission function and more particularly when determining certain portions of the transmission function can be fixedly stored in an adjustment instrument prior to carrying out an adjustment session. However, the weighting is preferably adaptive. Thus, the data obtained from various tests can be subjected to a plausibility check for example and the weighting of implausible or less plausible data can be reduced.

There are situations in which the data usually obtained from a test cannot be determined in its entirety, for example if even a standard audiogram can only be recorded in an incomplete fashion. However, the adjustment algorithms of modern hearing aids to a large extent work entirely on the basis of pure tone audiograms. All that are known are transformation methods from BERA data to standard audiograms; however, no direct combination of data records is provided in this case either. Integrating further measurement results has not been provided up until now.

The data from the individual tests can be incomplete, inconsistent or untypical, or even erroneous. In particular, the individual tests generally only supply data in respect of part of the frequency range that can be transmitted by the hearing aid to be adjusted. However, the inventive combination of all available data in a computational unit where possible allows hearing aid parameter settings to be obtained automatically, by means of which a hearing aid operated therewith compensates the present loss of hearing of the relevant user in an optimized fashion. More particularly, combining the data from the different tests allows the transmission function to be fixed automatically for the entire frequency range that can be transmitted by the hearing aid.

The relevant hearing aid parameters more particularly fix the amplification of an input signal at the respective frequency entering the hearing aid. Suitable settings of the hearing aid parameters, that is to say certain values for the respective parameter being fixed, more particularly determine the transmission function of the relevant hearing aid.

Hearing aids in general do not transmit the entire audible frequency range (0 to approximately 20 kHz), but only a certain frequency range, e.g. 0 to 8 kHz. Thus, it is usually completely sufficient for audiological data from the user to be determined for only this frequency range.

The algorithm used in the computational unit is based on at least one mathematical method, by means of which a suitable data record is determined from a plurality of data records with punctiform and/or incomplete and/or inconsistent and/or untypical and/or erroneous data. The mathematical methods that can be utilized include the use of lookup tables, data clustering methods, factor analysis methods, etc. Incomplete data, that is to say regions within the relevant frequency range for which there is available no data or only data with an insufficient density, can be determined from the available data by extrapolation and/or interpolation. In the process, the available algorithm advantageously uses a number of the aforementioned methods for calculating hearing aid parameter settings. The utilized algorithm preferably takes into account all available audiological data of the user. The use of a neural network and/or fuzzy logic can also advantageously serve to calculate the hearing aid parameter settings.

Hearing aid parameter settings as per the present algorithm are preferably obtained automatically in a plurality of stages, with different procedures being possible.

In a first procedure, a complete data record with audiological data is first of all obtained from the individual data records with audiological data, from which complete data record the desired transmission function for a hearing aid with the appropriate parameter settings for compensating the individual loss of hearing is then derived in the second stage. The audiological data is complete in the complete data record, that is to say it is without gaps in the required form for the relevant frequency range that can be transmitted by the hearing aid. In the process, the hearing aid transmission function fixes the frequency response of the relevant hearing aid and hence the amplification of an input signal as a function of the signal frequency. The required hearing aid parameter settings for obtaining the desired frequency response can then be determined from the desired frequency response.

In a second procedure, individual, generally incomplete and/or fragment-like and/or inconsistent hearing aid transmission functions (part-transmission functions) are determined directly from individual data records with audiological data, which part-transmission functions can be limited to a portion of the relevant frequency range. Subsequently, a complete, that is to say extending over the entire relevant frequency range, hearing aid transmission function is determined from the individual transmission functions as per the algorithm according to the invention, from which complete hearing aid transmission function the hearing aid parameter settings required for obtaining this transmission function are then derived.

According to a preferred embodiment of the invention, there advantageously are a number of predetermined data records in the computational unit more particularly covering the entire relevant frequency range that mirror (e.g. typical audiograms) the profile of typical losses of hearing and/or determine typical hearing aid transmission functions (gain settings), with the utilized algorithm selecting the predetermined data record that in each case fits best.

The algorithm for obtaining hearing aid parameter settings can be implemented on a specific hearing aid adjustment computer. However, the algorithm is advantageously implemented on a hand-held instrument, such as a hearing aid remote control, a cellular telephone or a personal digital assistant (PDA). Here, the data is preferably input manually. However, automatic, wired or wireless input of data is also possible, for example data based on the measurement of otoacoustic emissions (OAE) or acoustic evoked potentials (AEP).

The hand-held instrument can also at the same time serve as a programming interface for the hearing aid for wireless or wired programming. As an alternative, the hand-held instrument can also only determine the parameter values from a record of general hearing aid parameter settings, in particular by using a lookup table.

Other features which are considered as characteristic for the invention are set forth in the appended claims.

Although the invention is illustrated and described herein as embodied in a method for adjusting a hearing aid and hearing aid adjustment instrument, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a flowchart for a method according to the invention; and

FIG. 2 shows how an amplification characteristic is obtained for a hearing aid on the basis of hearing tests that are conducted by applying four different test methods.

### DETAILED DESCRIPTION OF THE INVENTION

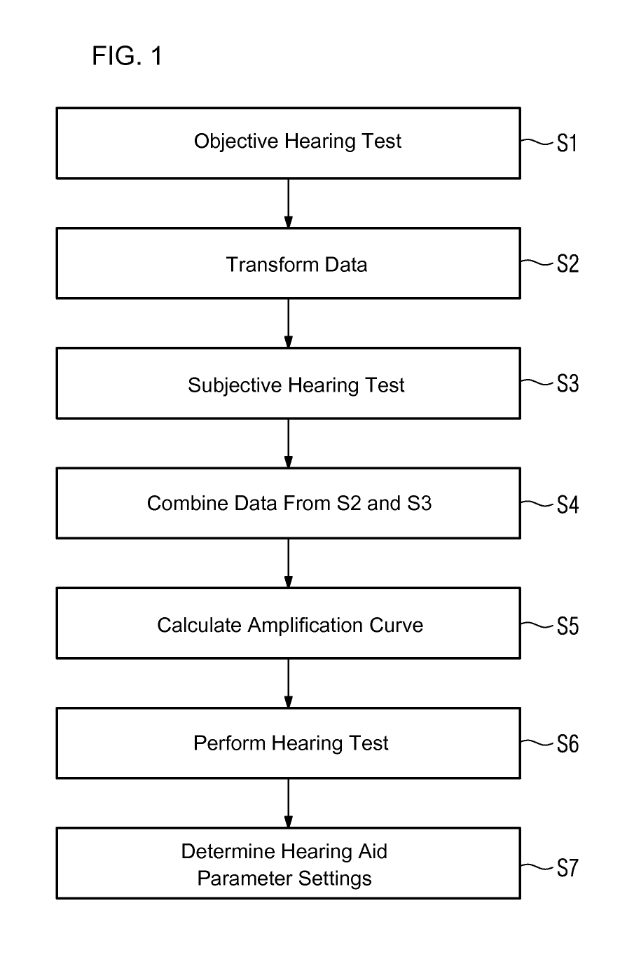

Referring now to the figures of the drawing in detail and first, particularly, to FIG. 1 thereof, there is shown an exemplary flowchart. There, at least one hearing test is first of all performed in a first method step S1 using an objective test method (objective hearing test), e.g. an impedance measurement, a measurement of otoacoustic emissions, BERA or CERA measurements, speech audiometry, etc.

In a second method step S2 there subsequently is a transformation of the data obtained from the objective hearing test into equivalent data from standard audiometry. Depending on the type of the underlying measurement, the algorithm for the data processing advantageously utilized uses different transformation curves. It can be assumed that it is not always a precise tone audiogram value, but more likely an estimation interval, that can be determined for a given frequency.

Furthermore, at least one hearing test using a subjective test method (subjective hearing test), e.g. tone audiometry or loudness scaling, is performed in a method step S3.

Subsequently, in a further method step S4, the data obtained in method step S2 and the data obtained in method step S3 are combined in a preferably weighted combination. In the ideal case, this can be carried out by simple averaging of the preferably transformed measurement values. Neural networks or fuzzy logic can advantageously be used in the case of conflicting data or missing values. These neural networks should run through a learning phase before they are used, during which learning phase they are trained in respect of typical losses of hearing and their associated objective and subjective measurement results in order to make the audiological pattern recognition simpler in the respectively present data record at a later stage. Further learning based on new measurements can be possible, but it is not required. Alternatively, an assignment of the various measurement values to a loss of hearing category can be carried out by means of data clustering analysis. Here, there is also the essential prerequisite of collecting different types of loss of hearing in advance together with their associated measurement data.

In the subsequent method step S5, an amplification curve is calculated from the combined data obtained in method step S4.

Optionally, in a further method step S6, there is at least one hearing test for determining the resolving capabilities of the hearing, for localizing or for speech intelligibility taking into account CERA and/or BERA data for determining feature parameters of a hearing aid to be set, e.g. in respect of the noise suppression, speech-sensitive processing or directional microphone setting.

Finally, hearing aid parameter settings are determined in a method step S7 (likewise optional) as a function of the data determined in method step S6.

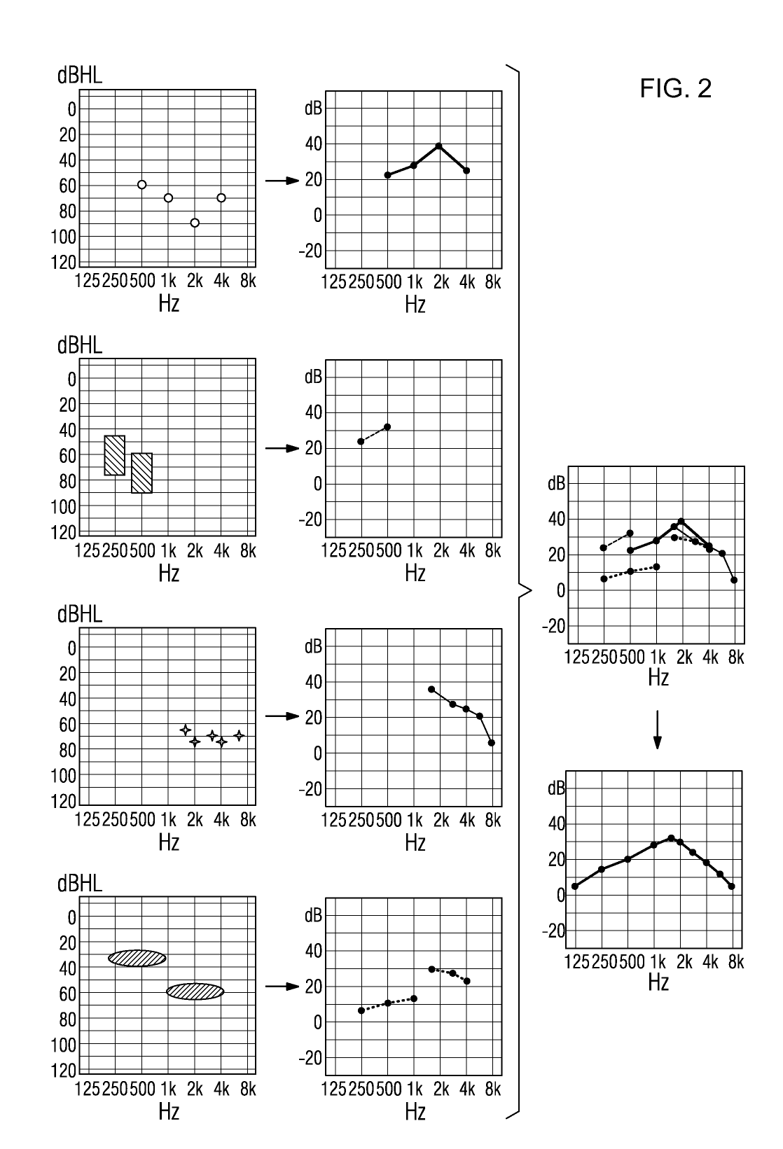

Referring now to FIG. 2, there are shown the results from four different test methods, by means of which data relating to the auditory perception (audiological data) of a user was obtained. In the illustrated sequence in the left column of the figure these are, from top to bottom:
the result of a hearing test with a hearing test instrument, in which the hearing threshold was determined at four different frequencies,
the result of a speech intelligibility test,
the result of a measurement of otoacoustic emissions (OAE), and
the result of a measurement of brainstem potentials.

The results of the hearing tests when applying the four different test methods are illustrated graphically in each case in the left column in FIG. 2. What is illustrated in each case is the loss of hearing at the respective signal frequency determined by the test. The result of each test method is preferably subsequently transferred automatically to a standard audiogram by means of the utilized algorithm. The individual underlying test methods accordingly only supply data for a portion of the frequency range (part-frequency range) that can be transmitted by the hearing aid, from which data the loss of hearing of the relevant person emerges at different frequencies in a fragment-like fashion. Accordingly, required amplification values for an input signal for compensating the individual loss of hearing in the test person obtained can be determined from the results obtained by the individual test methods, see the graphs in the second column of FIG. 2. The graphs show that the amplification values are in each case only determined, more particularly calculated or established by means of lookup tables, for that frequency range for which data is also available from the respective test method. Accordingly, it is only a part-transmission function of the hearing aid that is determined in each case.

In the graph in the third column, the upper diagram now illustrates the results of all graphs of the second column unified in a single diagram. This shows that the test methods lead to inconsistent results. More particularly, a number of different amplification values result for individual frequencies. Therefore, according to the invention, the fragment-like amplification characteristics resulting from the different test methods are subsequently combined to a unified amplification characteristic that is continuous over the entire required frequency range. In the process, a multiplicity of different mathematical methods can be used, either individually or in combination. Examples of this include: averaging, forming data clusters, factor analysis, extrapolation, etc. Furthermore, a continuous amplification characteristic for the relevant frequency range can also be determined by applying neural networks and/or fuzzy logic. It is also possible for the most suitable amplification characteristic to be selected from a number of predetermined amplification characteristics. The result of this calculation is illustrated in the exemplary embodiment in the lower diagram in the right (third) column.

A preferred embodiment of the invention provides for different weighting of the audiological data obtained by different test methods. In the process, the different weighting can be effected automatically, for example by virtue of the fact that the data obtained by a speech test are included in determining the hearing aid parameter settings with a higher weighting than data from a simple hearing test (measurement of the hearing threshold). Different weightings can moreover be fixed by manual user inputs on an individual basis. Moreover, automatic evaluation of the present data is also possible. Thus, a data record with very many measurement points can be afforded a higher weighting than a data record with only a few measurement points. A plausibility check can also lead to different weightings. Thus, a data record with many implausible measurement points can be downgraded in respect of its weighting.

The invention provides for the implementation of an algorithm in a hearing aid adjustment instrument, which implements the above-described procedure. In the process, this is preferably a hand-held instrument. The audiological data obtained by applying different test methods are entered into the hearing aid adjustment instrument. Additionally, or alternatively, the hearing aid adjustment instrument can itself also generate audiological data, for example by carrying out a simple hearing test. The hearing aid adjustment instrument automatically generates hearing aid parameter settings from the audiological data in the described fashion and transmits said hearing aid parameter settings to a hearing aid to be adjusted, and so the hearing aid brings about a transmission function in respect of an input signal entering the hearing aid, by means of which the individual loss of hearing of the user is compensated.

It will be understood by those of skill in the pertinent art that the invention is not subject to any limitations in respect of the type and number of test methods that can be used for determining audiological data. In the simplest case only one hearing test method is used and the amplification characteristic with the best match to the test result is selected from a collection of predetermined transmission characteristics.

1. A method for automatically adapting a transmission function of a hearing aid to an individual loss of hearing of a user, the method which comprises:
performing different tests and applying different test methods for obtaining data relating to an auditory perception of the user; and
determining the transmission function in dependence on the data obtained in the different tests, and thereby differently weighting the data obtained in the different tests when determining the transmission function.

2. The method according to claim 1, which comprises weighting the data obtained in the different tests with frequency-dependent weighting in the step of determining the transmission function.

3. The method according to claim 2, wherein the data obtained from the different tests respectively at least substantially only influence the transmission function in a portion of a transmittable frequency range of the hearing aid.

4. The method according to claim 2, wherein, in a first portion of the transmittable frequency range, the transmission function is influenced, at least to a significant extent, only by the data obtained from a first test and, in a second part of the frequency range, the transmission function is influenced, at least to a significant extent, only by the data obtained from a second test.

5. The method according to claim 2, which comprises using the data emerging from the different tests in each case to determine part-transmission functions of the hearing aid for a part-frequency range and combining the part-transmission functions to the transmission function for the transmittable frequency range of the hearing aid.

6. The method according to claim 2, which comprises combining the data emerging from the different tests to data for the entire transmittable frequency range of the hearing aid and determining the transmission function from the data for the entire transmittable frequency range.

7. The method according to claim 1, which comprises extrapolating the data required for determining the transmission function, but not available from the different tests, from the available data.

8. The method according to claim 1, which comprises determining an removing inconsistencies in the data.

9. The method according to claim 1, which comprises determining the transmission function from the data obtained in the different tests by applying methods for data clustering.

10. The method according to claim 1, which comprises determining the transmission function from the data obtained in the different tests by applying methods for factor analysis.

11. The method according to claim 1, which comprises selecting the transmission function from a number of predetermined transmission functions.

12. A hearing aid adjustment instrument configured to carry out the method according to claim 1.
